(19) United States
(12) Patent Application Publication
(10) Pub. No.: US 2015/0167983 A1
(43) Pub. Date: Jun. 18, 2015

(54) BUNDLED TUBE FUEL INJECTOR TUBE TIP

(71) Applicant: General Electric Company, Schenectady, NY (US)

(72) Inventors: Johnie F. McConnaughhay, Greenville, SC (US); Steven Charles Woods, Easley, SC (US); Mark Carmine Bellino, Greenville, SC (US); James Christopher Monaghan, Moore, SC (US); Jonathan Dwight Berry, Simpsonville, SC (US)

(73) Assignee: General Electric Company, Schenectady, NY (US)

(21) Appl. No.: 14/105,368

(22) Filed: Dec. 13, 2013

(51) Int. Cl. F23R 3/28; F02M 61/14; F02C 7/22

(52) U.S. Cl. CPC F23R 3/283; F02C 7/222; F02M 61/14; F05D 2240/35; F05D 2230/30

(57) ABSTRACT

A bundled tube fuel injector includes a fuel plenum defined within the bundled tube fuel injector and a plurality of pre-mix tubes that extend downstream from the fuel plenum substantially parallel to one another. Each pre-mix tube includes an end portion and a radially extending end surface. An additively manufactured tube tip is fixedly connected to the end portion of a corresponding pre-mix tube.

### FIELD OF THE INVENTION

The present invention generally involves a bundled tube fuel injector such as may be incorporated into a combustor of a gas turbine or other turbomachine. Specifically, the invention relates to a bundled tube fuel injector having additively manufactured tube tips.

### BACKGROUND OF THE INVENTION

Gas turbines are widely used in industrial and power generation operations. A typical gas turbine may include a compressor section, a combustion section disposed downstream from the compressor section, and a turbine section disposed downstream from the combustion section. A working fluid such as ambient air flows into the compressor section where it is progressively compressed before flowing into the combustion section. The compressed working fluid is mixed with a fuel and burned within one or more combustors of the combustion section to generate combustion gases having a high temperature, pressure, and velocity. The combustion gases flow from the combustors and expand through the turbine section to produce thrust and/or to rotate a shaft, thus producing work.

The combustors may be annularly arranged between the compressor section and the turbine section. In a particular combustor design, the combustors include one or more axially extending bundled tube fuel injectors that extend downstream from an end cover.

The bundled tube fuel injector generally includes a plurality of pre-mix tubes arranged radially and circumferentially across the bundled tube fuel injector. The pre-mix tubes extend generally parallel to one another. An outer shroud extends circumferentially around the pre-mix tubes downstream from a fuel distribution module of the bundled tube fuel injector. An aft plate extends radially and circumferentially across a downstream end of the outer shroud adjacent to a combustion chamber or zone defined within the combustor. A cooling air or purge air plenum is at least partially defined within the outer shroud between the fuel distribution manifold and the aft plate. In a conventional bundled tube fuel injector, a downstream or end portion of each pre-mix tube extends through the aft plate such that an outlet of each tube is downstream from a hot side surface of the aft plate, thus providing for fluid communication into the combustion chamber or zone.

Each of the pre-mix tubes extends generally axially through the fuel distribution module and the cooling air plenum. The compressed working fluid is routed through inlets of each of the parallel pre-mix tubes upstream from the fuel distribution module. Fuel is supplied to the fuel plenum through the fluid conduit and the fuel is injected into the pre-mix tubes through one or more fuel ports defined within each of the pre-mix tubes. The fuel and compressed working fluid mix inside the pre-mix tubes before flowing out of the outlet which is defined at the downstream or end portion of each of the pre-mix tubes and into the combustion chamber or zone for combustion.

During operation of the combustor, the downstream or end portion of the pre-mix tubes is exposed to extreme temperatures due their proximity to the combustion chamber and/or the combustion flame. Over time, the downstream or end portion of the pre-mix tubes degrades due to the thermal stresses, thus requiring scheduled inspection and in some cases repair or refurbishment of the bundled tube fuel injectors. Materials that are suitable for high or extreme temperatures and that may enhance the life of the pre-mix tubes are relatively expensive. As a result it may be impractical and/or cost prohibitive to manufacture the pre-mix tubes entirely from these materials. Therefore, an improved bundled tube fuel injector would be useful.

### BRIEF DESCRIPTION OF THE INVENTION

Aspects and advantages of the invention are set forth below in the following description, or may be obvious from the description, or may be learned through practice of the invention.

One embodiment of the present invention is a bundled tube fuel injector. The bundled tube fuel injector includes a fuel plenum defined within the bundled tube fuel injector and a plurality of pre-mix tubes that extend downstream from the fuel plenum substantially parallel to one another. Each pre-mix tube includes an end portion and a radially extending end surface. An additively manufactured tube tip is fixedly connected to the end portion of a corresponding pre-mix tube.

Another embodiment of the present disclosure is a combustor. The combustor includes an outer casing that at least partially encases the combustor and an end cover that is coupled to the outer casing. A bundled tube fuel injector extends downstream from the end cover. The bundled tube fuel injector comprises a fuel plenum that is defined within the bundled tube fuel injector and a plurality of pre-mix tubes that extend downstream from the fuel plenum substantially parallel to one another. At least one of the pre-mix tubes is in fluid communication with the fuel plenum and each pre-mix tube includes an end portion and a radially extending end surface. An additively manufactured tube tip is fixedly connected to the end portion of a corresponding pre-mix tube.

Another embodiment of the present disclosure includes a gas turbine. The gas turbine includes a compressor, a combustor disposed downstream from the compressor and that is at least partially encased within an outer casing, and a turbine disposed downstream from the combustor. The combustor includes an end cover coupled to the outer casing and a bundled tube fuel injector that extends downstream from the end cover. The bundled tube fuel injector comprises a fuel plenum that is defined within the bundled tube fuel injector and a plurality of pre-mix tubes that extend downstream from the fuel plenum substantially parallel to one another. Each pre-mix tube includes an end portion and a radially extending end surface. The bundled tube fuel injector further comprises an additively manufactured tube tip that is fixedly connected to the end portion of a corresponding pre-mix tube.

Those of ordinary skill in the art will better appreciate the features and aspects of such embodiments, and others, upon review of the specification.

### BRIEF DESCRIPTION OF THE DRAWINGS

A full and enabling disclosure of the present invention, including the best mode thereof to one skilled in the art, is set forth more particularly in the remainder of the specification, including reference to the accompanying figures, in which:

FIG. 1 provides a functional block diagram of an exemplary gas turbine that may incorporate various embodiments of the present invention;

FIG. 2 is a simplified cross-section side view of an exemplary combustor as may incorporate various embodiments of the present invention;

FIG. 3, is a cross section perspective view of an exemplary bundled tube fuel injector according to one embodiment of the present invention;

FIG. 4, is an enlarged cross sectional side view of a portion of the bundled tube fuel injector as shown in FIG. 3, according to various embodiments of the present invention;

FIG. 5, is an enlarged cross sectional side view of a portion of the bundled tube fuel injector as shown in FIG. 3 including an additively manufacture tube tip, according to various embodiments of the present invention;

FIG. 6, is an enlarged cross sectional side view of a portion of an exemplary pre-mix tube and an additively manufacture tube tip according to various embodiments of the present invention; and

FIG. 7, is an enlarged cross sectional side view of a portion of an exemplary pre-mix tube including an additively manufacture tube tip and a sleeve according to various embodiments of the present invention.

### DETAILED DESCRIPTION OF THE INVENTION

Reference will now be made in detail to present embodiments of the invention, one or more examples of which are illustrated in the accompanying drawings. The detailed description uses numerical and letter designations to refer to features in the drawings. Like or similar designations in the drawings and description have been used to refer to like or similar parts of the invention. As used herein, the terms “first”, “second”, and “third” may be used interchangeably to distinguish one component from another and are not intended to signify location or importance of the individual components. The terms “upstream” and “downstream” refer to the relative direction with respect to fluid flow in a fluid pathway. For example, “upstream” refers to the direction from which the fluid flows, and “downstream” refers to the direction to which the fluid flows. The term “radially” refers to the relative direction that is substantially perpendicular to an axial centerline of a particular component, and the term “axially” refers to the relative direction that is substantially parallel to an axial centerline of a particular component.

Each example is provided by way of explanation of the invention, not limitation of the invention. In fact, it will be apparent to those skilled in the art that modifications and variations can be made in the present invention without departing from the scope or spirit thereof. For instance, features illustrated or described as part of one embodiment may be used on another embodiment to yield a still further embodiment. Thus, it is intended that the present invention covers such modifications and variations as come within the scope of the appended claims and their equivalents.

Although exemplary embodiments of the present invention will be described generally in the context of a bundled tube fuel injector incorporated into a combustor of a gas turbine for purposes of illustration, one of ordinary skill in the art will readily appreciate that embodiments of the present invention may be applied to any combustor incorporated into any turbomachine and are not limited to a gas turbine combustor unless specifically recited in the claims.

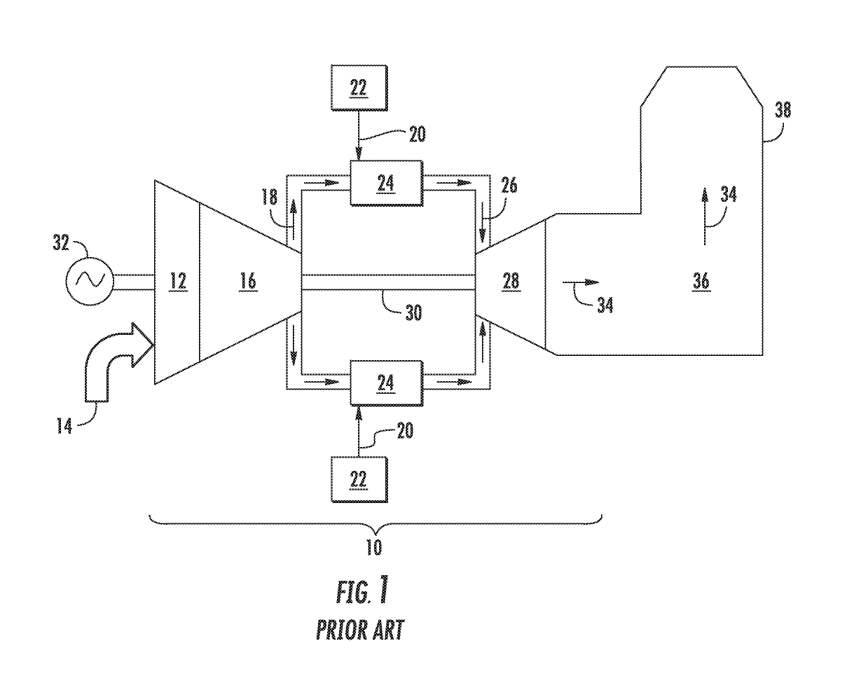

Referring now to the drawings, wherein identical numerals indicate the same elements throughout the figures, FIG. 1 provides a functional block diagram of an exemplary gas turbine 10 that may incorporate various embodiments of the present invention. As shown, the gas turbine 10 generally includes an inlet section 12 that may include a series of filters, cooling coils, moisture separators, and/or other devices to purify and otherwise condition a working fluid (e.g., air) 14 entering the gas turbine 10. The working fluid 14 flows to a compressor section where a compressor 16 progressively imparts kinetic energy to the working fluid 14 to produce a compressed working fluid 18.

The compressed working fluid 18 is mixed with a fuel 20 from a fuel source 22 such as a fuel skid to form a combustible mixture within one or more combustors 24. The combustible mixture is burned to produce combustion gases 26 having a high temperature, pressure and velocity. The combustion gases 26 flow through a turbine 28 of a turbine section to produce work. For example, the turbine 28 may be connected to a shaft 30 so that rotation of the turbine 28 drives the compressor 16 to produce the compressed working fluid 18. Alternately or in addition, the shaft 30 may connect the turbine 28 to a generator 32 for producing electricity. Exhaust gases 34 from the turbine 28 flow through an exhaust section 36 that connects the turbine 28 to an exhaust stack 38 downstream from the turbine 28. The exhaust section 36 may include, for example, a heat recovery steam generator (not shown) for cleaning and extracting additional heat from the exhaust gases 34 prior to release to the environment.

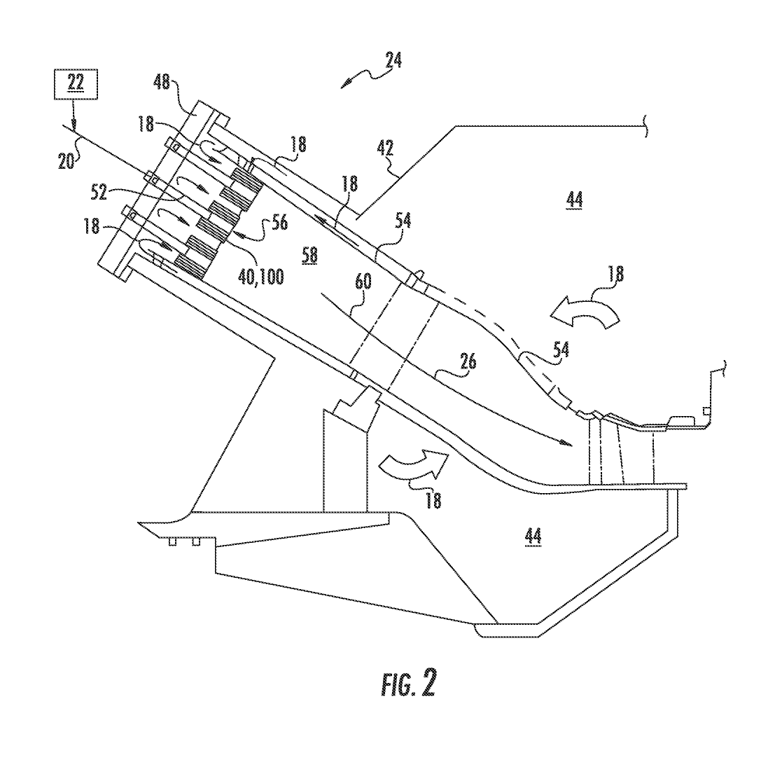

FIG. 2 provides a simplified cross section of an exemplary combustor 24 as may incorporate a bundled tube fuel injector 40 configured according to at least one embodiment of the present disclosure. As shown, the combustor 24 is at least partially surrounded by an outer casing 42. The outer casing 42 at least partially forms a high pressure plenum 44 around the combustor 24. The high pressure plenum 44 may be in fluid communication with the compressor 16 or other source for supplying the compressed working fluid 18 to the combustor 24. In one configuration, an end cover 48 is coupled to the outer casing 42. The end cover 48 may be in fluid communication with the fuel supply 22.

The bundled tube fuel injector 40 extends downstream from the end cover 48. The bundled tube fuel injector 40 may be fluidly connected to the end cover 48 so as to receive fuel from the fuel supply 22. For example, a fluid conduit 52 may provide for fluid communication between the end cover 48 and/or the fuel supply 22 and the bundled tube fuel injector 40. One end of an annular liner 54 such as a combustion liner and/or a transition duct surrounds a downstream end 56 of the bundled tube fuel injector 40 so as to at least partially define a combustion chamber 58 within the combustor 24. The liner 54 at least partially defines a hot gas path 60 for directing the combustion gases 26 from the combustion chamber 58 through the combustor 24. For example, the hot gas path 60 may be configured to route the combustion gases 26 towards the turbine 28 and/or the exhaust section.

In operation, the compressed working fluid 18 is routed towards the end cover 48 where it reverses direction and flows through one or more of the bundled tube fuel injectors 40. The fuel 20 is provided to the bundled tube fuel injector 40 and the fuel 20 and the compressed working fluid 18 are premixed or combined within the bundled tube fuel injector 40 before being injected into a combustion chamber 58 for combustion.

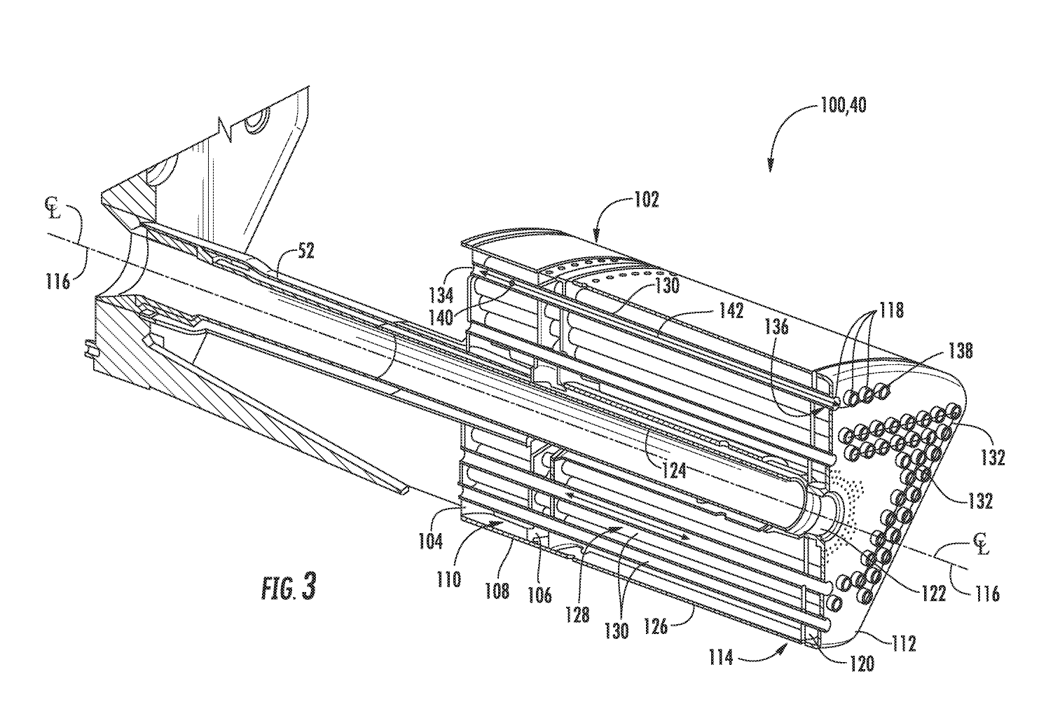

FIG. 3 is a cross section perspective view of an exemplary bundled tube fuel injector 100 herein referred to as “fuel injector” as may be incorporated into the combustor 24 as described in FIG. 2, according to various embodiments of the present disclosure. As shown, the fuel injector 100 generally includes a fuel distribution module 102 that is in fluid communication with the fluid conduit 52. In particular embodiments, the fuel distribution module 102 includes an upstream plate 104 that is axially separated from a downstream plate 106. The upstream and downstream plates 104, 106 extend generally radially and circumferentially within the fuel injector 100. An outer band 108 circumferentially surrounds and extends axially between the upstream and downstream plates 104, 106. The outer band 108 may extend axially beyond either one or both of the upstream and downstream plates 104, 106. A fuel plenum 110 may be at least partially defined between the upstream and downstream plates 104, 106 and the outer band 108. The fluid conduit 52 provides for fluid communication between the fuel supply 22 (FIG. 1) and the fuel plenum 110.

In particular configurations, an aft plate 112 is disposed at a downstream or aft end 114 of the fuel injector 100. The aft plate 112 extends radially outwardly and circumferentially across the aft end 114 with respect an axial centerline 116 of the fuel injector 100. The aft plate 112 at least partially defines a plurality of tube tip passages 118 that extend generally axially through the aft plate 112.

In particular embodiments, an impingement plate 120 is disposed upstream from the aft plate 112. The impingement plate 120 may be welded, brazed or otherwise coupled to the aft plate 112. The aft plate 112 and/or the impingement plate 120 may at least partially define a cartridge or fuel nozzle passage 122 that extends generally axially therethrough. A fluid cartridge 124 such as a diffusion fuel nozzle may be coupled to the aft plate 112 at the center nozzle passage 122. An outer shroud 126 may extend generally axially between the fuel distribution module 102 and the aft plate 112. The outer shroud 126 may be coupled to the aft plate 112 and/or the fuel distribution module 102 via welding, brazing, mechanical fasteners or by any suitable means for the operating environment of the fuel injector 100.

As shown in FIG. 3, the fuel injector 100 includes a pre-mix tube bundle 128. The pre-mix tube bundle 128 comprises a plurality of pre-mix tubes 130 that extend generally parallel to one another along or parallel to the axial centerline 116 of the fuel injector 100. The pre-mix tubes 130 extend downstream from the fuel plenum 110 towards the aft plate 112 and/or the combustion chamber 58 (FIG. 2). A portion of the pre-mix tubes 130 extends through the fuel plenum 110.

The pre-mix tubes 130 may be formed from a single continuous tube or may be formed from two or more coaxially aligned tubes fixedly joined together. Although generally illustrated as cylindrical, the pre-mix tubes 130 may be any geometric shape, and the present invention is not limited to any particular cross-section unless specifically recited in the claims. In addition, the pre-mix tubes 130 may be grouped or arranged in circular, triangular, square, or other geometric shapes, and may be arranged in various numbers and geometries.

In one embodiment, each pre-mix tube 130 is generally aligned with a corresponding tube tip passage 118. In one embodiment, the pre-mix tubes 130 are arranged in multiple rows 132. Each row 132 may include one or more of the pre-mix tubes 130. In one embodiment, each row 132 is radially spaced with respect to the axial centerline 116 from an adjacent row 132. The pre-mix tubes 130 of at least some of the rows 132 may be arranged annularly around the axial centerline 116. The pre-mix tubes 130 of each row 132 may be arranged generally circumferentially across the fuel injector 100 with respect to an axial centerline of the combustor 24 and/or the axial centerline 116 of the fuel injector 100.

An exemplary pre-mix tube 130, as shown in FIG. 3, generally includes an inlet 134 defined upstream from the fuel plenum 110 and/or the upstream plate 104. The inlet 134 may be in fluid communication with the high pressure plenum 44 and/or the compressor 16. A downstream or end portion 136 is defined downstream from the fuel plenum 110. A radially extending surface 138 is defined between an inner and outer diameter of the pre-mix tube 130 at a distal end of the end portion 136. One or more fuel ports 140 may provide for fluid communication between the fuel plenum 110 and a corresponding pre-mix passage 142 at least partially defined by the pre-mix tubes 130.

FIG. 4 is an enlarged cross sectional side view of a portion of the fuel injector 100 as shown in FIG. 3, including a portion of the pre-mix tubes 130 of the tube bundle 128, the aft plate 112 and the outer shroud 126, according to various embodiments of the present disclosure. In various embodiments, as shown in FIG. 4, the end portions 136 of the pre-mix tubes 130 are positioned axially upstream from the aft plate 112 and/or the impingement plate 120 (FIG. 3). In other words, the pre-mix tubes 130 end upstream from the aft plate 112 and/or the impingement plate 120 (FIG. 3) within the fuel injector 100.

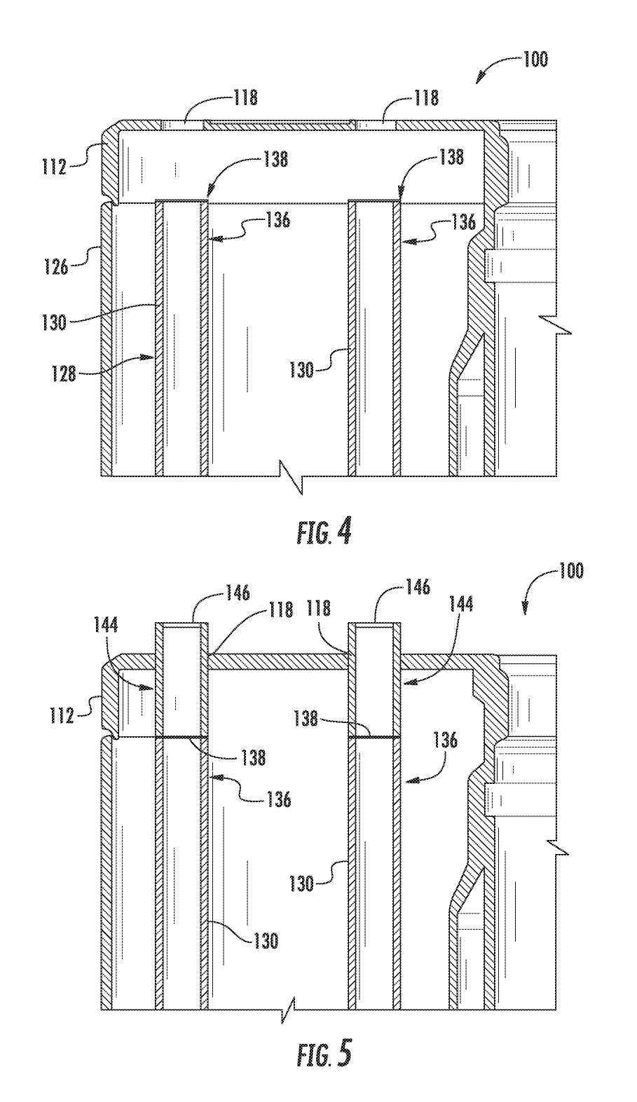

FIG. 5 is an enlarged cross sectional side view of a portion of the fuel injector 100 as shown in FIG. 4, including additively manufactured tube tips 144 herein referred to as “tube tips”, according to one embodiment of the present disclosure. As used herein, the term “additively manufactured” or “additive manufacturing process” corresponds but is not limited to various known 3D printing manufacturing methods such as Extrusion Deposition, Wire, Granular Materials Binding, Powder Bed and Inkjet Head 3D Printing, Lamination and Photopolymerization. The various technologies related to the various 3D printing methods include but are not limited to unless recited in the claims, fused deposition modeling (FDM), electron beam free-from fabrication (EBF), direct metal laser sintering (DMLS), Electron Beam Melting (EBM), Selective Laser Melting (SLM), Selective Heat Sintering (SHS), Selective Laser Sintering (SLS), Plaster-based 3D Printing (PP), Laminated Object Manufacturing (LOM), Stereolithography (SLA) and Digital Light Processing (DLP).

In various embodiments, the tube tips 144 extend axially away from the end portion 136 of a corresponding pre-mix tube 130. The tube tips 144 further define the pre-mix flow passage 142 for each of the pre-mix tubes 130 and provide an outlet 146 for the pre-mix flow passage 142 that is proximate to the combustion chamber 58 (FIG. 2). In one embodiment, the tube tips 144 extend through a corresponding tube tip passage 118 of the aft plate 112. In one embodiment, the tube tips 144 are fixedly connected to the end portion 136 of a corresponding pre-mix tube 130. For example, the tube tips 144 may be brazed or welded to the end portion 136. In one embodiment, the tube tips 144 are formed or additively manufactured directly on the radially extending surface 138 of the pre-mix tubes 130.

In particular embodiments, the tube tips 144 comprise high temperature alloys that are dissimilar to a material that forms the corresponding pre-mix tube 130. For example, but not by limitation, the additively manufactured tube tips 144 may comprise of at least one of nickel, cobalt, chromium, molybdenum, stainless steel, aluminum or titanium based alloys. In particular embodiments, the tube tips 144 comprise a similar alloy to the alloy that forms the pre-mix tube 130.

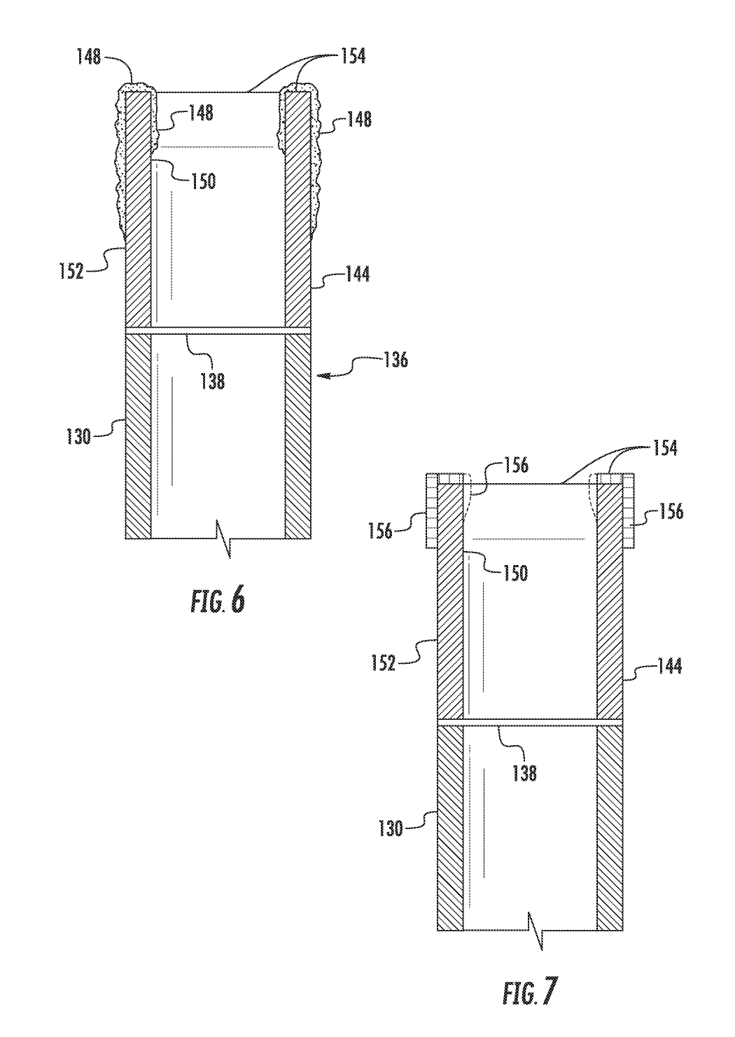

FIG. 6 is a cross section side view of a portion of an exemplary pre-mix tube 130 and a tube tip 144 fixedly connected thereto. In one embodiment, a coating 148 is disposed along at least a portion of the tube tip 144. As shown, the coating 148 may extend along an inner surface 150, an outer surface 152 and/or across a radially extending end surface 154 of the tube tip 144. In one embodiment, the coating 148 may comprise a thermal coating or thermal barrier coating to provide and/or improve thermal resistance to the high thermal stresses produced by the combustion flame and/or combustion gases. In one embodiment, the coating 148 comprises a wear coating to provide and/or improve mechanical performance of the tube tip 144, particularly where the tube tip 144 may contact the aft plate 112 at the tube tip passages 118 and/or the impingement plate 120 (FIG. 3). In addition or in the alternative, the wear coating may provide or enhance oxidation and corrosion performance of the tube tip 144.

The coating 148 may be applied to the tube tip 144 p via plating, coating, etc., In particular embodiments, the coating 148 may comprise of chrome, nickel, gel aluminide coating, aluminide coating, TBC, L605 and Stellite 6. The coating may be applied using any process in any manner know to one of ordinary skill, including but not limited to Electron Beam Physical Vapor Deposition (EBPVD), Air Plasma Spray (APS), High Velocity Oxygen Fuel (HVOF), Electrostatic Spray Assisted Vapor Deposition (ESAVD) or Direct Vapor Deposition (DVD).

FIG. 7 is a cross section side view of a portion of an exemplary pre-mix tube 130, a tube tip 144 fixedly connected thereto and a sleeve 156 that extends at least partially around at least a portion of the tube tip 144. For example, the sleeve 156 may extend across at least a portion of one or more of the outer surface 152, the radially extending surface 154 or the inner surface 150. The sleeve 156 may provide and/or improve thermal resistance to the high thermal stresses produced by the combustion flame and/or combustion gases. In addition or in the alternative, the sleeve 156 may provide and/or improve mechanical performance of the tube tip 144 by reducing wear and/or enhancing oxidation and corrosion performance of the tube tip 144.

The sleeve 156 may comprise high temperature alloys that are dissimilar to a material that forms the corresponding tube tip 144. For example, but not by limitation, the sleeve 156 may comprise at least one of nickel, cobalt, chromium, molybdenum, stainless steel, aluminum or titanium based alloys. In particular embodiments, the sleeve 156 comprises a similar alloy to the alloy that forms at least one of the pre-mix tube 130 or the tube tip 144.

The various embodiments as described herein and as illustrated in FIGS. 5-7 provide a method for manufacturing and/or repairing the bundled tube fuel injector 100. For example, in one embodiment, the method includes preparing the end portion 138 of the pre-mix tube 130. For example, the step of preparing the end portion 138 may include cutting away a damaged portion of the pre-mix tube 130, brushing, sanding, grinding, cleaning, polishing or coating the end portion 138 and/or the radially extending surface 138 of the pre-mix tube 130. The method may further include additively manufacturing the tube tip 144. The tube tip 144 may be additively manufactured as an individual component or may be formed or additively manufactured directly on or along the radially extending surface 138 of the pre-mix tube 130. The method may further include applying the coating 148 to the tube tip 144. The method may further include fixedly connecting the tube tip 144 to the end portion 138 and/or the radially extending surface 138 of the pre-mix tube 130.

The various embodiments provided herein, provide various technical advantages over existing bundled tube fuel injectors. For example, the tube tips 144 may reduce costs currently associated with the manufacture, repair and/or replacement of pre-mix tubes. In addition, the tube tips 144 provide a two part tubing system that allows for design flexibility in material selection which may enhance mechanical and thermal performance of the bundled tube fuel injector 100, thus increasing part life.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal language of the claims.

What is claimed is:

1. A bundled tube fuel injector, comprising:
a fuel plenum defined within the bundled tube fuel injector;
a plurality of pre-mix tubes that extend downstream from the fuel plenum substantially parallel to one another, each pre-mix tube having an end portion and a radially extending end surface; and
an additively manufactured tube tip fixedly connected to the end portion of a corresponding pre-mix tube.

2. The bundled tube fuel injector as in claim 1, wherein the additively manufactured tube tip comprises at least one of a nickel, cobalt, titanium or stainless steel based alloy.

3. The bundled tube fuel injector as in claim 1, wherein the additively manufactured tube tip is manufactured via at least one of selective laser melting, direct metal laser sintering, selective laser sintering, fused deposition modeling, stereo lithography and laminated object manufacturing.

4. The bundled tube fuel injector as in claim 1, wherein the additively manufactured tube tip is manufactured directly along a radially extending surface defined at the end portion of the corresponding pre-mix tube.

5. The bundled tube fuel injector as in claim 1, further comprising an aft plate defining a plurality of tube tip passages, wherein the additively manufactured tube tip extends through a corresponding tube tip passage.

6. The bundled tube fuel injector as in claim 1, further comprising a coating disposed along at least a portion of the additively manufactured tube tip.

7. The bundled tube fuel injector as in claim 7, wherein the coating comprises a thermal barrier coating.

8. The bundled tube fuel injector as in claim 7, wherein the coating comprises a wear resistant coating.

9. A combustor, comprising:
an outer casing that at least partially encases the combustor;
an end cover coupled to the outer casing; and
a bundled tube fuel injector that extends downstream from the end cover, the bundled tube fuel injector comprising:
a fuel plenum defined within the bundled tube fuel injector;
a plurality of pre-mix tubes that extend downstream from the fuel plenum substantially parallel to one another, at least one of the pre-mix tubes being in fluid communication with the fuel plenum, each pre-mix tube having an end portion and a radially extending end surface; and
an additively manufactured tube tip fixedly connected to the end portion of a corresponding pre-mix tube.

10. The combustor as in claim 9, wherein the additively manufactured tube tip comprises at least one of a nickel, cobalt or stainless steel based alloy.

11. The combustor as in claim 9, wherein the additively manufactured tube tip is manufactured via at least one of selective laser melting, direct metal laser sintering, selective laser sintering, fused deposition modeling, stereo lithography and laminated object manufacturing.

12. The combustor as in claim 9, wherein the additively manufactured tube tip is manufactured directly along a radially extending surface defined at the end portion of the corresponding pre-mix tube.

13. The combustor as in claim 9, further comprising an aft plate defining a plurality of tube tip passages, wherein the additively manufactured tube tip extends through a corresponding tube tip passage.

14. The combustor as in claim 9, further comprising a coating disposed along at least a portion of the additively manufactured tube tip.

15. The combustor as in claim 14, wherein the coating comprises at least one or a thermal barrier coating and a wear resistant coating.

16. A gas turbine, comprising:
a compressor;
a combustor downstream from the compressor, wherein the combustor is at least partially encased within an outer casing;
a turbine disposed downstream from the combustor; and
wherein the combustor includes an end cover coupled to the outer casing and a bundled tube fuel injector that extends downstream from the end cover, the bundled tube fuel injector comprising:
a fuel plenum defined within the bundled tube fuel injector;
a plurality of pre-mix tubes that extend downstream from the fuel plenum substantially parallel to one another, each pre-mix tube having an end portion and a radially extending end surface; and
an additively manufactured tube tip fixedly connected to the end portion of a corresponding pre-mix tube.

17. The gas turbine as in claim 16, wherein the additively manufactured tube tip comprises at least one of a nickel, cobalt or stainless steel based alloy.

18. The gas turbine as in claim 16, wherein the additively manufactured tube tip is manufactured via at least one of selective laser melting, direct metal laser sintering, selective laser sintering, fused deposition modeling, stereo lithography and laminated object manufacturing.

19. The gas turbine as in claim 16, wherein the additively manufactured tube tip is manufactured directly along a radially extending surface defined at the end portion of the corresponding pre-mix tube.

20. The gas turbine as in claim 16, further comprising a coating disposed along at least a portion of the additively manufactured tube tip, wherein the coating comprises at least one or a thermal barrier coating and a wear resistant coating.
